(19) United States
(12) Patent Application Publication
(10) Pub. No.: US 2023/0097758 A1
(43) Pub. Date: Mar. 30, 2023

(54) CONTROL SYSTEM, CONTROL METHOD, AND NON-TRANSITORY COMPUTER READABLE STORAGE MEDIUM

(71) Applicant: KABUSHIKI KAISHA TOKAI RIKA DENKI SEISAKUSHO, Aichi (JP)

(72) Inventors: Kazunori SOBUE, Aichi (JP); Hideki KAWAI, Aichi (JP); Masanori KOSUGI, Aichi (JP)

(73) Assignee: KABUSHIKI KAISHA TOKAI RIKA DENKI SEISAKUSHO, Aichi (JP)

(21) Appl. No.: 17/851,435

(22) Filed: Jun. 28, 2022

(30) Foreign Application Priority Data
Sep. 30, 2021 (JP) 2021-160921

(51) Int. Cl. E05F 15/73; B60R 25/01; B60R 25/31

(52) U.S. Cl. CPC E05F 15/73; B60R 25/01; B60R 25/31; E05Y 2400/44; E05Y 2400/45; E05Y 2400/858; E05Y 2900/531; E05Y 2900/546

(57) ABSTRACT

A control system comprising: a sensor configured to measure a distance to an object, and obtain a distance measurement value, the object existing in a measurement target space that is a space in which a position of an upper limb of a user who tries to operate a target object that is an object controlled by the control system is assumed to be found, and the distance measurement value being a value that indicates the measured distance; and a control section configured to execute a process related to the target object based on the distance measurement value obtained by the sensor.

### CROSS REFERENCE TO RELATED APPLICATION(S)

This application is based upon and claims benefit of priority from Japanese Patent Application No. 2021-160921, filed on Sep. 30, 2021, the entire contents of which are incorporated herein by reference.

### BACKGROUND

The present invention relates to a control system, a control method, and a non-transitory computer readable storage medium.

A technology that detects a user's gesture based on information measured by a sensor, and performs an operation matching the detected gesture has been developed. For example, following JP 6537488 B2 discloses a technology that detects a kicking operation of lifting one foot closer to a sensor by using the sensor provided at a lower part of a door of a vehicle, and opens and closes the door.

### SUMMARY

However, the kicking operation causes various inconveniences that, for example, an unstable posture for lifting the one foot is forced.

Accordingly, the present invention is made in view of the aforementioned issues, and an object of the present invention is to provide a mechanism that can reduce inconveniences caused for a user upon an operation.

### Solution to Problem

To solve the above described problem, according to an aspect of the present invention, there is provided a control system comprising: a sensor configured to measure a distance to an object, and obtain a distance measurement value, the object existing in a measurement target space that is a space in which a position of an upper limb of a user who tries to operate a target object that is an object controlled by the control system is assumed to be found, and the distance measurement value being a value that indicates the measured distance; and a control section configured to execute a process related to the target object based on the distance measurement value obtained by the sensor.

To solve the above described problem, according to another aspect of the present invention, there is provided a control method that is executed by a control system, the control method comprising: measuring a distance between an object and a sensor, and obtaining a distance measurement value, the object existing in a measurement target space that is a space in which a position of an upper limb of a user who tries to operate a target object that is an object controlled by the control system is assumed to be found, and the distance measurement value being a value that indicates the measured distance; and executing a process related to the target object based on the obtained distance measurement value.

To solve the above described problem, according to another aspect of the present invention, there is provided a non-transitory computer readable storage medium having a program stored therein, the program causing a computer configured to control a control system to: measure a distance between an object and a sensor, and obtain a distance measurement value, the object existing in a measurement target space that is a space in which a position of an upper limb of a user who tries to operate a target object that is an object controlled by the control system is assumed to be found, and the distance measurement value being a value that indicates the measured distance; and execute a process related to the target object based on the obtained distance measurement value.

### Advantageous Effects of Invention

As described above, the present invention provides a mechanism that can reduce inconveniences caused for a user upon an operation.

### BRIEF DESCRIPTION OF THE DRAWINGS

FIG. 1 is a block diagram illustrating an example of a configuration of a control system according to an embodiment of the present invention.

FIG. 2 is a view for explaining an example of a measurement target space according to the present embodiment.

FIG. 3 is a view for explaining an example of a driving condition according to the present embodiment.

FIG. 4 is a flowchart illustrating an example of a flow of a process executed by the control system according to the present embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Configuration Example

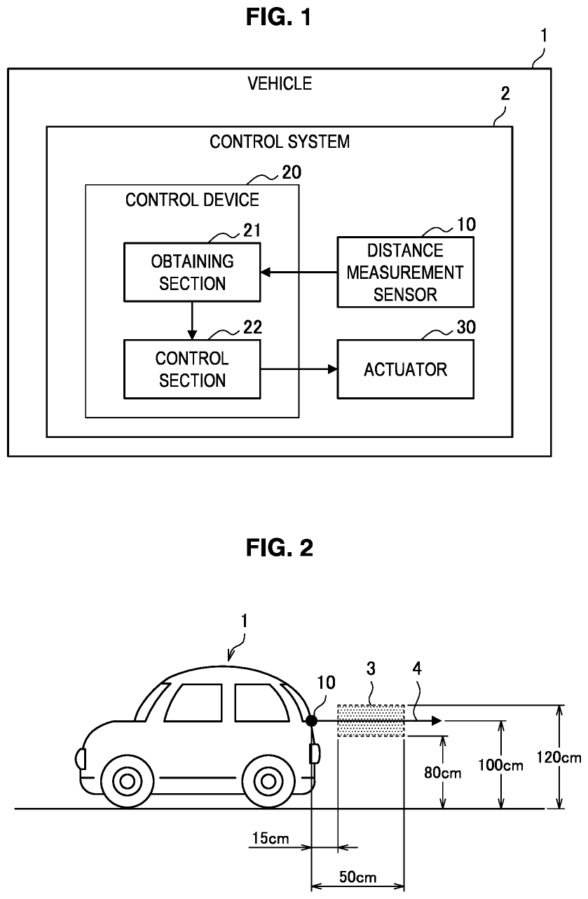

FIG. 1 is a block diagram illustrating an example of a configuration of a control system 2 according to an embodiment of the present invention. As illustrated in FIG. 1, the control system 2 is mounted on a vehicle 1. The control system 2 is a system that controls operations of the vehicle 1. The control system 2 includes a distance measurement sensor 10, a control device 20, and an actuator 30.

(Distance Measurement Sensor 10)

The distance measurement sensor 10 is a sensor that measures a distance to an object. More specifically, the distance measurement sensor 10 transmits a transmission wave, and receives a reflected wave that is the transmission wave reflected by the object. Furthermore, the distance measurement sensor 10 measures the distance between the distance measurement sensor 10 and the object based on a time length from transmission of the transmission wave to reception of the reflected wave. The transmission wave may be an arbitrary wave such as a radio wave, a sonic wave, or an ultrasonic wave.

Above all, the distance measurement sensor 10 measures a distance to an object that exists in a measurement target space. The measurement target space refers to a space in which a position of an upper limb of a user who tries to operate a target object that is a target controlled by the control system 2 is assumed to be found. The upper limb described herein is a body part from a shoulder to a fingertip including the shoulder, an upper arm, a knee, a forearm, a wrist, and a hand. That is, the measurement target space is a space in which a position of the body part from the shoulder to the fingertip of the user is assumed to be found. Above all, the measurement target space only needs to include a space in which the position of the hand or the knee is assumed to be found. A gesture operation is frequently performed by the hand or the knee. According to this configuration, it is possible to measure a distance from the distance measurement sensor 10 to the upper limb of the user who tries to operate the target object. An example of the measurement target space will be described with reference to FIG. 2.

FIG. 2 is a view for explaining the example of the measurement target space according to the present embodiment. As illustrated in FIG. 2, the distance measurement sensor 10 may be provided to a door (also referred to as a luggage door below) of a trunk provided at a rear part of the vehicle 1. The distance measurement sensor 10 is provided at a position that is at 100 cm in ground height. A measurement target space 3 is a space that is at 15 cm or more and 50 cm or less on a back side of the vehicle 1, and is at 80 cm or more and 120 cm or less in ground height.

Note that the distance measurement sensor 10 may be able to measure a distance to an object that exists outside the measurement target space, too. For example, the distance measurement sensor 10 may be able to obtain a distance measurement value that indicates a distance equal to or more than 50 cm. On the other hand, 15 cm that is a lower limit value of the distance from the measurement target space 3 to the distance measurement sensor 10 may be a lower limit value of a distance that can be measured in a specification of the distance measurement sensor 10.

As illustrated in FIG. 2, the distance measurement sensor 10 transmits a transmission wave 4 to the measurement target space 3. Furthermore, the distance measurement sensor 10 receives a reflected wave that is the transmission wave 4 reflected by an object located in the measurement target space 3, and measures a distance to the object. The distance measurement sensor 10 can receive the reflected wave reflected by the object located in the measurement target space 3 by transmitting the transmission wave 4 such that the transmission wave 4 passes through the measurement target space 3. The distance measurement sensor 10 may transmit the transmission wave 4 that has directivity in a horizontal direction. In this case, it is possible to suppress reflection from a ground, and measure a distance in the horizontal direction to the object located in the measurement target space 3. In this example, the target object is the actuator 30 that opens and closes the luggage door. A user 5 can cause the control system 2 to open the luggage door by performing a predetermined operation by the upper limb in the measurement target space 3.

The measurement target space 3 includes a space that is apart in the horizontal direction from the distance measurement sensor 10. According to this configuration, it is possible to obtain a distance measurement value that indicates the distance to the upper limb of the user 5 who exists at the position apart in the horizontal direction from the distance measurement sensor 10.

The measurement target space 3 includes a space in which the upper limb of the user 5 who stands at the position apart in the horizontal direction from the distance measurement sensor 10 is assumed to be found. According to this configuration, it is possible to obtain a distance measurement value that indicates a distance to the upper limb of the user 5 who stands at the position apart in the horizontal direction from the distance measurement sensor 10.

The measurement target space 3 includes a space in which the position of the body of the user 5 is assumed to be found. The body described herein refers to a so-called body trunk other than the upper limb, a lower limb, and a head. According to this configuration, it is possible to obtain a distance measurement value that indicates a distance to at least one of the upper limb and the body of the user 5.

The distance measurement sensor 10 obtains a distance measurement value that is a value that indicates a measured distance. Furthermore, the distance measurement sensor 10 outputs the obtained distance measurement value to the control device 20. The distance measurement sensor 10 repeatedly measures the distance. Furthermore, the distance measurement sensor 10 repeatedly outputs the distance measurement value to the control device 20.

(Actuator 30)

The actuator 30 has a function of driving an arbitrary part that makes up the vehicle 1. For example, the actuator 30 may be a motor that opens and closes the luggage door. The actuator 30 opens and closes the luggage door of the vehicle 1 based on control performed by the control device 20.

(Control Device 20)

The control device 20 is a device that controls an operation of each device mounted on the vehicle 1. For example, the control device 20 controls an operation of the actuator 30 based on the distance measurement value obtained by the distance measurement sensor 10. As illustrated in FIG. 1, the control device 20 includes an obtaining section 21 and a control section 22.

Obtaining Section 21

The obtaining section 21 has a function of obtaining the distance measurement value that is the value that indicates the distance measured by the distance measurement sensor 10. The obtaining section 21 obtains the distance measurement value repeatedly output by the distance measurement sensor 10. The obtaining section 21 outputs the obtained distance measurement value to the control section 22.

Control Section 22

The control section 22 has a function of executing a process related to the target object based on the distance measurement value obtained by the obtaining section 21. For example, the control section 22 causes the actuator 30 to operate as a process that is based on the distance measurement value when the distance measurement value satisfies a predetermined condition (also referred to as a driving condition below). The driving condition is that the distance measurement value obtained when the upper limb of the user performs a predetermined operation (also referred to as a target operation below) in the measurement target space can be obtained. The target operation is an operation that triggers the operation of the actuator 30 and is performed by the user.

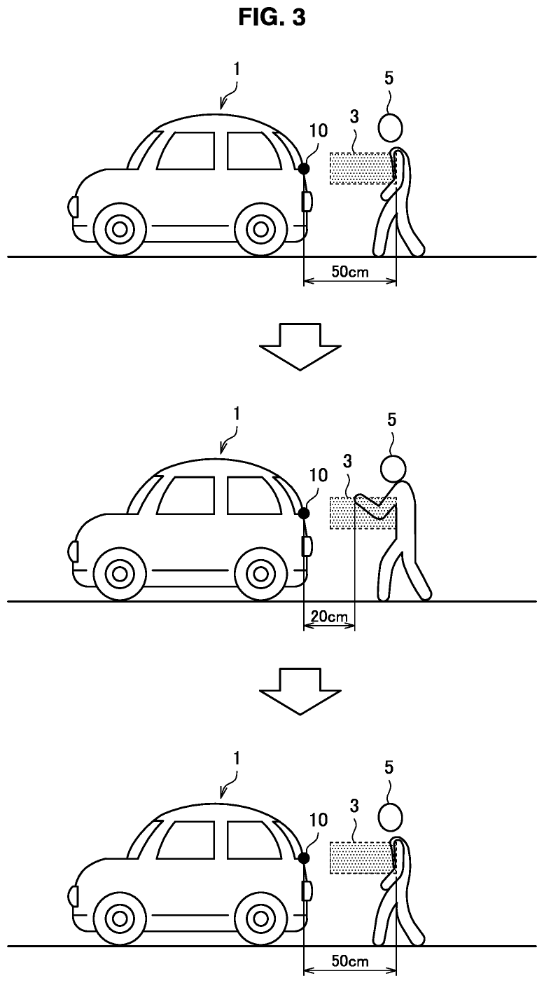

The driving condition may be that a distance measurement value included in a first range that is a range of a distance measurement value corresponding to a distance of a specific range is obtained, a distance measurement value included in a second range that is a range of a distance measurement value corresponding to a distance shorter than the first range is next obtained, and a distance measurement value included in the first range is then obtained. An example of the first range is a range of 50 cm±several cm. An example of the second range is a range of 20 cm±several cm. In this case, an example of the target operation is an operation where the user stands at a position approximately 50 cm from the distance measurement sensor 10, holds the hand or the knee over a position approximately 20 cm from the distance measurement sensor 10, and returns the hand or the knee. Furthermore, the driving condition is that the distance measurement value changes from approximately 50 cm to approximately 20 cm, and further changes to approximately 50 cm. According to this configuration, that the user has performed the target operation can trigger the operation of the actuator 30. The above-described driving condition will be more specifically described with reference to FIG. 3.

FIG. 3 is a view for explaining an example of the driving condition according to the present embodiment. When the user 5 stands at a position that is on the back side of the vehicle 1 and is at approximately 50 cm from the distance measurement sensor 10 as illustrated in an upper stage of FIG. 3, a distance measurement value that indicates approximately 50 cm in distance from the distance measurement sensor 10 to the body of the user 5. Next, when the user 5 holds the hand over the position approximately 20 cm from the distance measurement sensor 10 as illustrated in a middle stage of FIG. 3, a distance measurement value that indicates approximately 20 cm in distance from the distance measurement sensor 10 to the hand of the user 5 is obtained. Furthermore, when the user 5 returns the hand as illustrated in a lower stage of FIG. 3, a distance measurement value that indicates approximately 50 cm in distance from the distance measurement sensor 10 to the body of the user 5 is obtained. Thus, when the distance measurement value changes from approximately 50 cm to approximately 20 cm, and further changes to approximately 50 cm, it is possible to detect that the user has performed the target operation in the measurement target space 3. When it is detected that the target operation has been performed in the measurement target space 3, the control section 22 causes the actuator 30 to operate to open the luggage door.

(Effect)

A configuration of the control system 2 according to the present embodiment has been described above. As described above, when detecting based on the distance measurement value that the user has performed an operation of holding the upper limb over the vehicle 1 in the vicinity to the vehicle 1, the control system 2 opens the luggage door. This configuration exhibits various effective effects compared to a technology that is disclosed in above JP 6537488 B2 and detects a kicking operation to open and close the door.

First, the user does not have to take an unstable posture of lifting one foot. Consequently, the user can avoid a danger of falling down. This effect is particularly desirable for elderly people and pregnant women.

Stains such as dirt sprang from a road usually adheres to a lower part of the vehicle 1. Hence, when the kicking operation is performed, a piece of clothes or a shoe contacts the lower part of the vehicle 1, and the piece of clothes or the shoe may get dirty. In this regard, according to the present embodiment, it is only necessary to perform the target operation by the upper limb in the vicinity to the vehicle 1, so that it is possible to prevent the piece of clothes from getting dirty even if the upper limb contacts the vehicle 1.

Small animals such as cats may pass under the vehicle 1. Hence, it is concerned that the technology disclosed in above JP 6537488 B2 detects passing of the small animals as the kicking operation. In this regard, according to the present embodiment, a space through which small animals cannot pass is the measurement target space, so that it is possible to prevent erroneous detection of passing of the small animals, and prevent an erroneous operation of the actuator 30.

### 2. Flow of Process

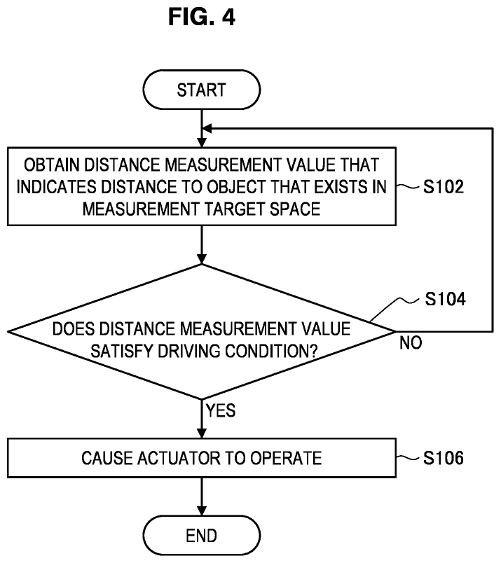

FIG. 4 is a flowchart illustrating an example of a flow of a process executed by the control system 2 according to the present embodiment.

As illustrated in FIG. 4, the distance measurement sensor 10 first obtains the distance measurement value that indicates the distance to the object that exists in the measurement target space (step S102).

Next, the control device 20 decides whether or not the obtained distance measurement value satisfies the driving condition (step S104). For example, the control device 20 decides whether or not the repeatedly obtained distance measurement value has changed from approximately 50 cm to approximately 20 cm, and further changed to approximately 50 cm.

When deciding that the driving condition has been satisfied (step S104: YES), the control device 20 causes the actuator 30 to operate. For example, the control device 20 causes the actuator 30 to operate to open the luggage door. Subsequently, the process is finished.

On the other hand, when it is decided that the driving condition is not satisfied (step S104: NO), the process returns to step S102 again.

### 3. Supplementary Explanation

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, although the above embodiment has described as the example of the driving condition that the distance measurement value changes from approximately 50 cm to approximately 20 cm, and further changes to approximately 50 cm, the present invention is not limited to this embodiment. The driving condition may be that the distance measurement value decreases by approximately 30 cm, and subsequently increases by approximately 30 cm. The driving condition may be any condition as long as the condition relates to a time series change of the distance measurement value.

For example, although the above embodiment has described the example where the actuator 30 opens and closes the luggage door, the present invention is not limited to this embodiment. The actuator 30 may open and close the door of the vehicle 1 such as a front door that is a door of a driver's seat or a passenger's seat or a rear door that is a door of a rear seat. Furthermore, the actuator 30 may drive an arbitrary part such as windows and side mirrors other than the doors that make up the vehicle 1. Similarly, the distance measurement sensor 10 is not limited to the example where the distance measurement sensor 10 is arranged at the luggage door, and the distance measurement sensor 10 only needs to be arranged at a position corresponding to a part driven by the actuator 30. Note that the distance measurement sensor 10 may be provided at a part different from the part driven by the actuator 30. For example, the distance measurement sensor 10 may be provided at the side mirror, and the actuator 30 may drive the front door.

For example, although the above embodiment has described the example where the control device 20 is provided to the vehicle 1, the present invention is not limited to this embodiment. For example, the control device 20 may be configured separately from the vehicle 1, and may be connected with the distance measurement sensor 10 and the actuator 30 provided to the vehicle 1 via, for example, a network.

For example, although the above embodiment has described the example where the distance measurement sensor 10 is provided to the vehicle 1, and the actuator 30 opens and closes the door of the vehicle 1, the present invention is not limited to this embodiment. The distance measurement sensor 10 may be provided to movable bodies such as airplanes and ships other than the vehicle 1. Furthermore, the actuator 30 may drive an arbitrary part such as a door or a wheel of the movable body. In addition, the distance measurement sensor 10 may be provided to a static object such as a building or a delivery box, and the actuator 30 may drive a part of the static object.

For example, although the above embodiment has described the example where the distance measurement sensor 10 transmits the transmission wave having the directivity in the horizontal direction, the present invention is not limited to this embodiment. The distance measurement sensor 10 may transmit a transmission wave by striking the transmission wave down to the ground, or may transmit a transmission wave by striking the transmission wave up to the sky. That is, the measurement target space may be apart in the horizontal direction and apart in a vertical direction from the distance measurement sensor 10.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

What is claimed is:

1. A control system comprising:
a sensor configured to measure a distance to an object, and obtain a distance measurement value, the object existing in a measurement target space that is a space in which a position of an upper limb of a user who tries to operate a target object that is an object controlled by the control system is assumed to be found, and the distance measurement value being a value that indicates the measured distance; and
a control section configured to execute a process related to the target object based on the distance measurement value obtained by the sensor.

2. The control system according to claim 1,
wherein the sensor measures the distance to the object to measure the distance to the object that exists in the measurement target space, the objecting existing in the measurement target space that includes a space apart in a horizontal direction from the sensor.

3. The control system according to claim 1,
wherein the sensor measures the distance to the object to measure the distance to the object that exists in the measurement target space, the object existing in the measurement target space that includes a space in which the position of the upper limb of the user who stands at a position apart in a horizontal direction from the sensor is assumed to be found.

4. The control system according to claim 1,
wherein the sensor measures the distance to the object to measure the distance to the object that exists in the measurement target space, the object existing in the measurement target space that includes a space in which a position of a body of the user is assumed to be found.

5. The control system according to claim 1,
wherein the sensor transmits a transmission wave to the measurement target space, receives a reflected wave that is the transmission wave reflected by the object, and measures the distance based on a time length from the transmission of the transmission wave to the reception of the reflected wave.

6. The control system according to claim 1,
wherein the control section executes the process related to the target object when the distance measurement value satisfies a predetermined condition to execute the process related to the target object based on the distance measurement value.

7. The control system according to claim 6, wherein
the sensor repeatedly measures the distance, and
the control section executes the process related to the target object when the distance measurement value included in a first range is obtained, the distance measurement value included in a second range is next obtained, and the distance measurement value included in the first range is then obtained to operate the target object when the distance measurement value satisfies the predetermined condition, the first range being a range of the distance measurement value corresponding to a distance of a specific range, and the second range being a range of the distance measurement value corresponding to a shorter distance than the first range.

8. The control system according to claim 1, wherein
the sensor is provided to a movable body,
the target object is an actuator configured to drive a part provided to the movable body, and
the control section causes the actuator to operate to execute the process related to the target object.

9. The control system according to claim 8, wherein
the sensor is provided to a vehicle,
the target object is an actuator configured to open and close a door of the vehicle, and
the control section causes the actuator to operate to execute the process related to the target object.

10. A control method that is executed by a control system, the control method comprising:
measuring a distance between an object and a sensor, and obtaining a distance measurement value, the object existing in a measurement target space that is a space in which a position of an upper limb of a user who tries to operate a target object that is an object controlled by the control system is assumed to be found, and the distance measurement value being a value that indicates the measured distance; and
executing a process related to the target object based on the obtained distance measurement value.

11. A non-transitory computer readable storage medium having a program stored therein, the program causing a computer configured to control a control system to:
measure a distance between an object and a sensor, and obtain a distance measurement value, the object existing in a measurement target space that is a space in which a position of an upper limb of a user who tries to operate a target object that is an object controlled by the control system is assumed to be found, and the distance measurement value being a value that indicates the measured distance; and
execute a process related to the target object based on the obtained distance measurement value.
